(19) United States
(12) Patent Application Publication
(10) Pub. No.: US 2019/0267757 A1
(43) Pub. Date: Aug. 29, 2019

(54) CONNECTORS FOR DRIVE CONTROLLERS FOR PUMP MOTORS

(71) Applicant: Zodiac Pool Systems LLC, Carlsbad, CA (US)

(72) Inventors: Dustin Borg, Poway, CA (US); James Hohn, San Diego, CA (US); Garrett Patrick McCormick, Manchester, MD (US)

(73) Assignee: Zodiac Pool Systems LLC, Carlsbad, CA (US)

(21) Appl. No.: 16/286,275

(22) Filed: Feb. 26, 2019

Related U.S. Application Data
(60) Provisional application No. 62/635,630, filed on Feb. 27, 2018.

(51) Int. Cl. H01R 13/631; F04D 13/06; H02K 11/33; H02K 5/10; H02K 5/22; H01R 13/52; H01R 13/64; H01R 43/26

(52) U.S. Cl. CPC H01R 13/631; F04D 13/0686; H02K 11/33; H02K 5/10; H02K 2213/12; H01R 13/5219; H01R 13/64; H01R 43/26; H02K 2211/03; H02K 5/225

(57) ABSTRACT

Apparatus, systems, and methods for connecting components are described. The components may be drive controls and motors of pumps of water-circulation systems needing to be connected both mechanically and electrically. The connectors may be robust and have alignment, sealing, and keying capabilities.

### CROSS-REFERENCE TO RELATED APPLICATION

This application claims the benefit of and priority to U.S. Provisional Patent Application Ser. No. 62/635,630, filed Feb. 27, 2018, and having the same title as appears above, the entire contents of which application are hereby incorporated herein by this reference.

### FIELD OF THE INVENTION

This invention relates to apparatus, systems, and methods for connecting drive controls to motors and more particularly, although not necessarily exclusively, to devices providing mechanical and electrical connections between drive controllers and motors of pumps of water-circulation systems of swimming pools and spas.

### BACKGROUND OF THE INVENTION

Multi-speed motors are configured to change rotational speed upon command. Such commands may originate with a computerized controller capable of transmitting the commands to a motor. Although transmission may occur wirelessly, often commands are transmitted via wire from controllers to motors.

Pumps used as parts of outdoor pool- and spa-water circulation systems frequently are positioned outdoors, near their associated pools or spas. Consequently, they are subject to being contacted by water, which may damage motors of the pumps. To minimize risk of water-intrusion damage, the motors typically are contained within waterproof housings. However, because the motors require electrical power to operate, at least some penetration of the housings typically is necessary to route electrical wires to the motors.

Moreover, at least some controllers are configured to mount onto the motor housings. These controllers, then, require both mechanical connections to the housings and electrical connections to the internal motors. At least some controllers, further, are designed or rated for use with motors of particular output, so that some method of ensuring that a controller and motor are compatible prior to attempted operation would be beneficial. Standardization of the connectors across a line of pumps of a manufacturer likewise may be advantageous.

### SUMMARY OF THE INVENTION

The present invention seeks to satisfy some of these requirements in beneficial manners. In some versions of the invention, alignment and keying of connectors may be intuitive and designed to reduce, if not minimize (or wholly prevent), errors in attaching drive controllers to motor housings. An installer may position a controller adjacent—and preferably above—a motor housing so that a tower of the housing aligns and fits snugly within a chimney-like opening of the controller. As the installer lowers the drive controller, a keying pin of the controller aligns with a mating hole of the motor housing. Continued lowering of the controller causes male electrical terminals of the controller to fit into female terminals of the motor housing configured to convey electricity to the motor inside the housing.

Proceeding in this manner results in mechanically and electrically connecting the drive controller to the motor housing while protecting the male terminals from misalignments that could causes breaking or bending. Female terminals too are protected from these misalignments. Proceeding in this way also permits keying of controllers to motor housings to ensure their operational compatibility and may effectively supply a seal between the two components to prevent ingress of debris and moisture. Additional benefits of the present invention may include its modular nature and capability of providing complete sealing between the printed circuit boards (PCBs) and housings of the drive controllers so that drive electronics can be encapsulated without leaking or contaminating the electrical terminals. Accordingly, the present invention may provide robust mechanical guidance and alignment, solid electrical connections, and inherent keying of drive controllers and motor housings.

It thus is an optional, non-exclusive object of the present invention to provide apparatus and methods for connecting components of, e.g., water-circulation systems of swimming pools or spas.

It is another optional, non-exclusive object of the present invention to provide systems and techniques for mechanically and electrically connecting drive controllers to motor housings.

It is a further optional, non-exclusive object of the present invention to provide robust connection mechanisms with alignment, sealing, and keying capabilities.

Other objects, features, and advantages of the present invention will be apparent to those skilled in the art with reference to the remaining text and the drawings of this application.

### BRIEF DESCRIPTION OF THE DRAWINGS

FIGS. 1-2 are views of a drive controller illustrating aspects of an exemplary keying system of the present invention.

FIGS. 3-4 are views of a motor housing illustrating aspects of the exemplary keying system of FIGS. 1-2.

FIG. 5 is a cross-sectional view of an exemplary connector design similar to the keying system of FIGS. 1-4.

### DETAILED DESCRIPTION

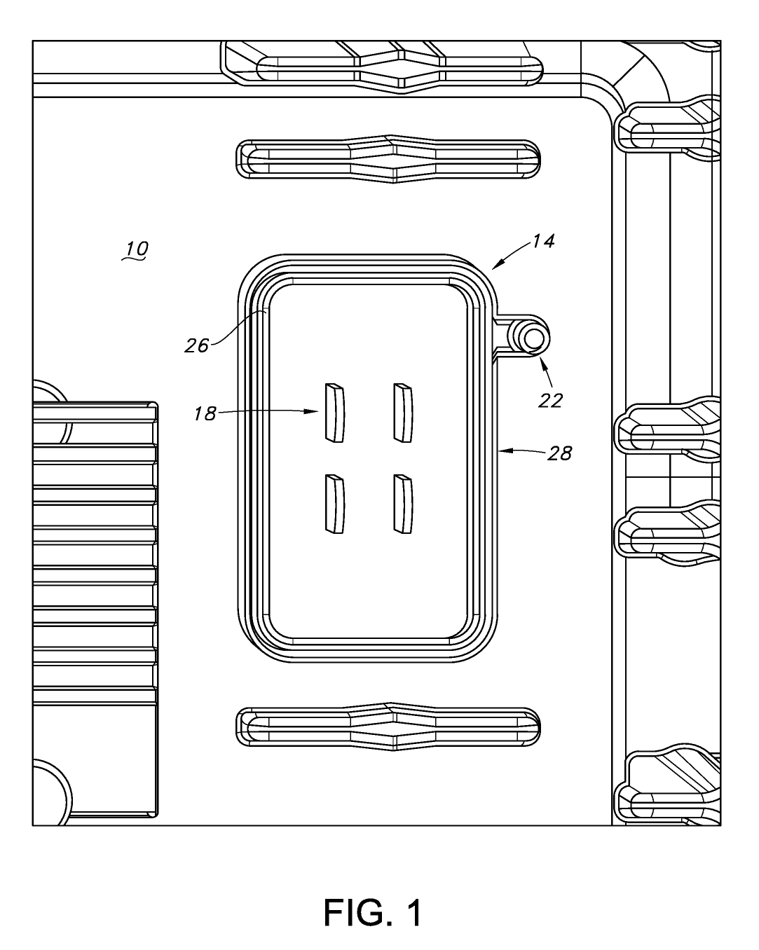

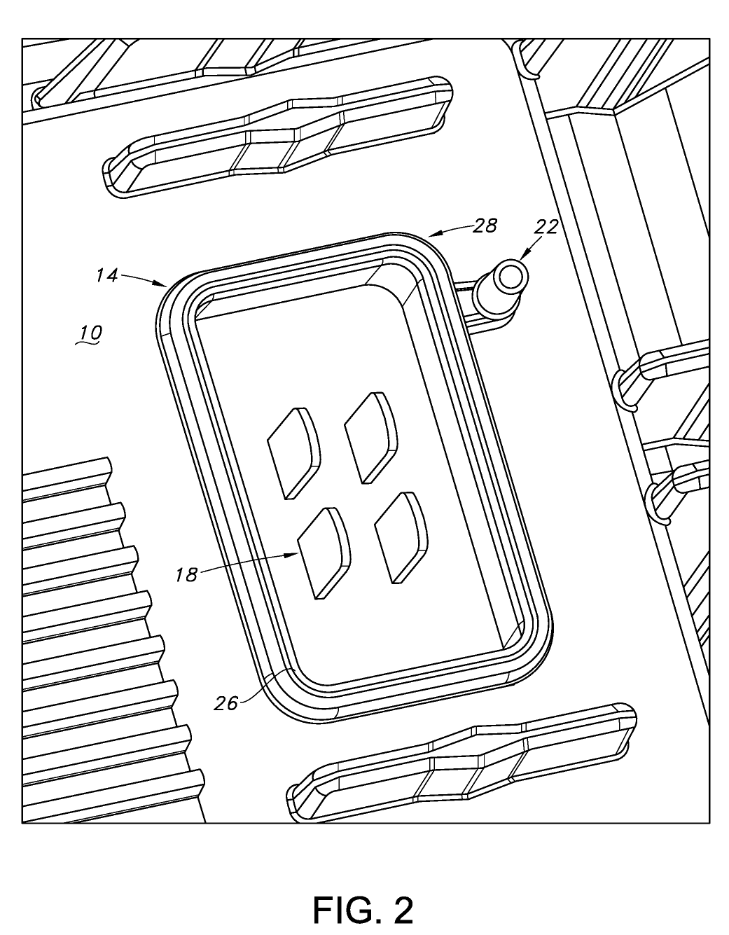

FIGS. 1-2 depict a (nominally lower) portion 10 of a drive controller including aspects of the present invention. Illustrated in FIGS. 1-2 is chimney 14, which as shown is recessed into the housing of the controller. Also shown in FIGS. 1-2 protruding outward from a base of the chimney 14 are male terminals 18. Terminals 18 may, but need not necessarily, be part of an interface PCB that mounts within chimney 14. Although four such terminals 18 are depicted, more or fewer terminals 18 may be used instead. In general, the walls of chimney 14 function to provide substantial protection for the terminals 18.

Shown too in FIGS. 1-2 is keying pin 22. As depicted, pin 22 protrudes outward from portion 10 adjacent chimney 14 and is of generally cylindrical shape. Pin 22 need not be positioned or shaped or sized as shown in FIGS. 1-2, however, depending on the structure to which it is to be keyed.

First gasket 26 further is illustrated in FIGS. 1-2. Gasket 26 may provide a seal between the PCB containing terminals 18 and the walls or upper lip 28 of chimney 14. Gasket 26 additionally may provide mechanical support (strain relief) to terminals 18.

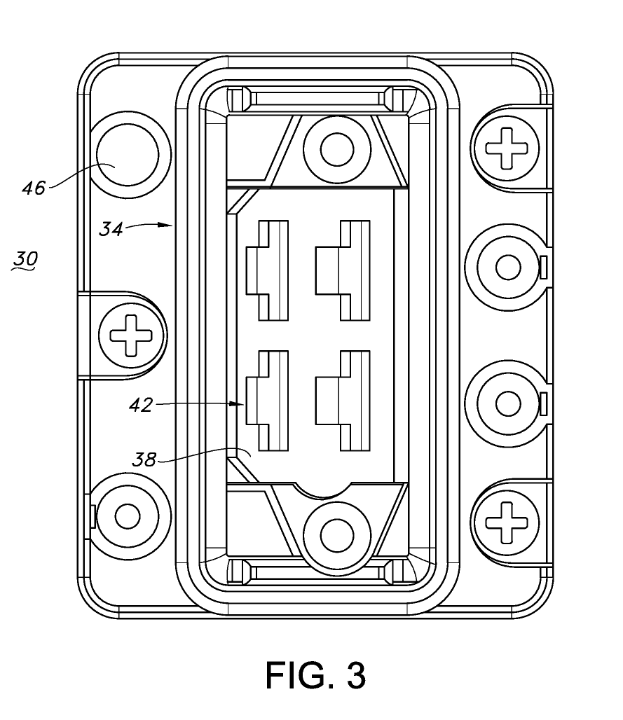

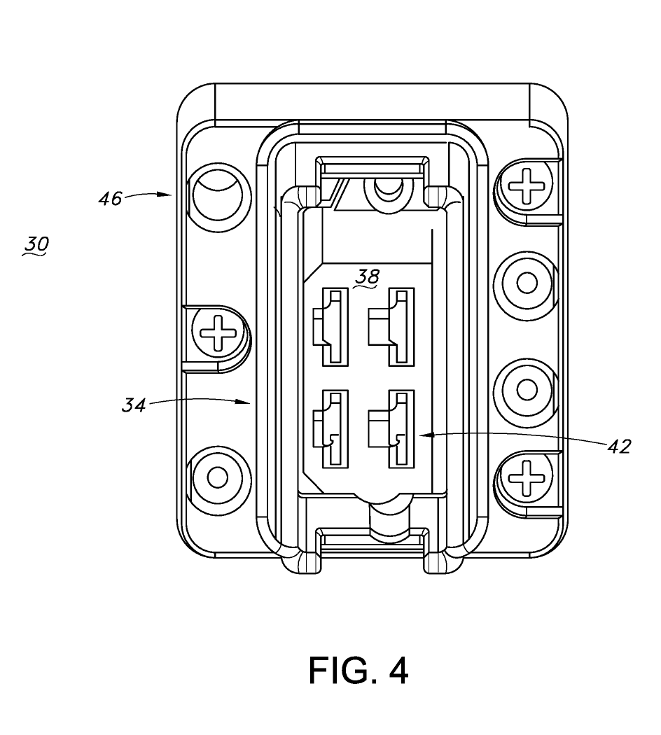

FIGS. 3-4 depict a (nominally upper) portion 30 of a motor housing including aspects of the present invention. Further depicted is motor connector tower 34, which may be secured to portion 30 and hold terminal block 38. Block 38 may contain female terminals 42 (preferably of the “FastOn”-type), four of which are shown. Tower 34, moreover, may include mating hole 46, which as shown constitutes a generally cylindrical recess positioned adjacent a tower wall.

Tower 34 is configured to fit snugly within chimney 14, thereby supplying initial alignment of the controller and motor housing before pin 22 reaches hole 46. Assuming pin 22 is sized, shaped, and positioned (i.e. keyed) so as to be received into hole 46, further tightening of the alignment may occur. These alignments facilitate mating of male terminals 18 and female terminals 42, hence reducing the possibility of the terminals being damaged by any misalignments that otherwise might exist. Alternatively, pin 22 may protrude sufficiently so that it engages hole 46 prior to contact between tower 34 and chimney 14, although this alternative approach presently is not preferred.

Supplemental gaskets may, if desired, be used. A second gasket, for example, may be placed at the base of tower 34 and function to seal space between tower 34 and chimney 14 to reduce ingress of debris and moisture into the space. A third gasket may be positioned under tower 34 to prevent ingress of debris and moisture into the motor within the motor housing.

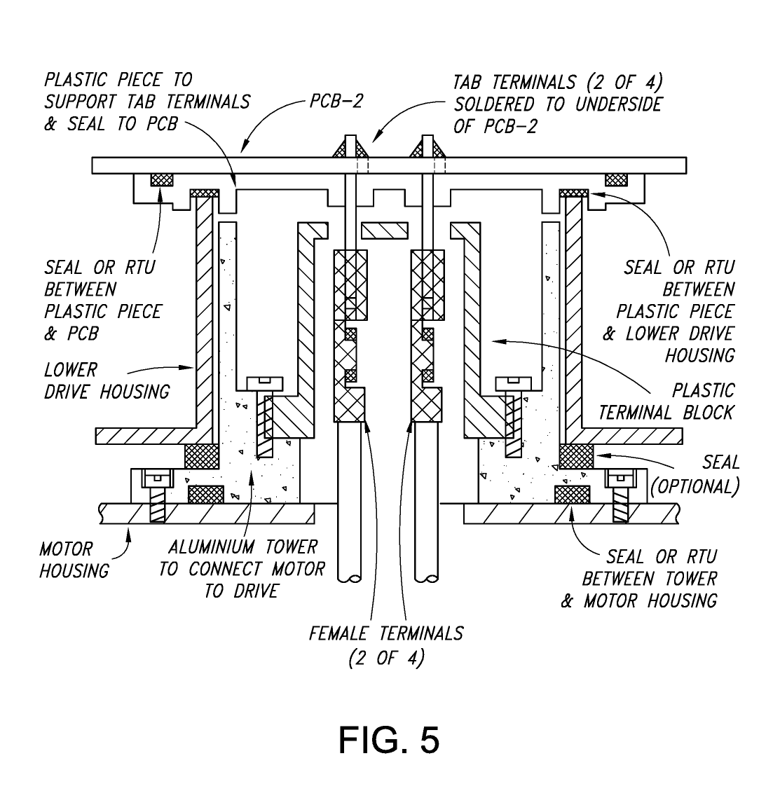

FIG. 5 provides a cross-sectional view of an exemplary connector design consistent with the present invention and similar to that of FIGS. 1-4. The figure is labelled to identify various components and features of the design.

The foregoing is provided for purposes of illustrating, explaining, and describing embodiments of the present invention. Modifications and adaptations to these embodiments will be apparent to those skilled in the art and may be made without departing from the scope or spirit of the invention. Additionally, the word “pool” and phrase “swimming pool” as used herein may include vessels such as spas and hot tubs within its definition.

What is claimed is:

1. A keying system comprising:
a. a recessed region of a first object defining a base and at least one wall;
b. at least one first terminal protruding outward from the base and protected at least in part by the wall;
c. a terminal block of a second object comprising at least one second terminal;
d. a keying pin protruding outward from either the first object or the second object; and
e. a mating hole of either the second object or the first object; and
in which (i) one of the first terminal or the second terminal is a male terminal and the other is a female terminal configured to receive the male terminal and (ii) the mating hole is configured to receive the keying pin.

2. A keying system according to claim 1 in which the female terminal receives the male terminal prior to the mating hole receiving the keying pin.

3. A keying system according to claim 2 in which the recessed region defines a chimney, further comprising a connector tower holding the terminal block and fitting snugly within the chimney.

4. A keying system according to claim 3 in which one of the first object or the second object is a drive controller and the other is a motor housing.

5. A keying system according to claim 4 in which the first object is the drive controller and the second object is the motor housing.

6. A keying system according to claim 5 in which the keying pin protrudes outward from the drive controller adjacent the chimney.

7. A keying system according to claim 6 in which the keying pin has cylindrical shape.

8. A keying system according to claim 7 in which the male terminal is part of a printed circuit board mounted within the chimney.

9. Equipment of a water-circulation system of a swimming pool or spa, comprising:
a. a drive controller comprising:
i. a housing;
ii. a chimney (A) recessed into the housing and (B) comprising a base and walls;
iii. male terminals (A) protruding outward from the base and (B) protected at least in part by the walls; and
iv. a keying pin protruding outward from the housing adjacent the chimney; and
b. a motor housing comprising a tower comprising:
i. a terminal block containing female terminals; and
ii. a mating hole; and
in which the tower is configured to fit snugly within the chimney and the keying pin is configured to be received into the mating hole.

10. A method of electrically and mechanically connecting a drive controller to a motor housing of a water-circulation system of a swimming pool or spa, the drive controller comprising a housing, a chimney recessed into the housing and comprising a base and walls, male terminals protruding outward from the base and protected at least in part by the walls, and a keying pin protruding outward from the housing adjacent the chimney, and the motor housing comprising a tower comprising a terminal block containing female terminals and a mating hole, the method comprising:
a. fitting the tower within the chimney so as to supply initial alignment of the drive controller and the motor housing; and
b. thereafter causing the keying pin to be received by the mating hole.

11. A method according to claim 10 further comprising selecting the drive controller from a set of drive controllers having keying pins protruding outward from different locations of their housings so that the keying pin of the selected drive controller is able to be received by the mating hole when the tower is fitted within the chimney.
